(19) United States
(12) Patent Application Publication
(10) Pub. No.: US 2007/0289987 A1
(43) Pub. Date: Dec. 20, 2007

(54) Modular Hand Care System

(76) Inventors: Paul Francis Tramontina, Alpharetta, GA (US); Andrew Clement, Alpharetta, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/611,269

(22) Filed: Dec. 15, 2006

Related U.S. Application Data
(60) Provisional application No. 60/804,983, filed on Jun. 16, 2006.

(51) Int. Cl. A47F 1/00; B67D 5/60

(52) U.S. Cl. 221/96; 222/132

(57) ABSTRACT

A modular hand care system that is customizable and expandable in its design, a method of providing such a system, and a module that may be used in such a system is disclosed. The modular nature of the system allows the consumer to dispense different product, easily configure the selected modules, quickly replace or add individual modules as the consumer desires. Such a system can be used at any location of the consumer's choosing; the system may be mounted on a wall, on a movable cart, or may be installed within a frame system.

This application claims priority to U.S. Provisional Application No. 60/804,983, entitled “MODULAR HAND CARE SYSTEM” and filed on Jun. 16, 2006, in the names of Paul F. Tramontina et al. which is incorporated herein by reference in its entirety.

### BACKGROUND

It is common in dirty industrial manufacturing sites to find hand cleaning stations at one or more locations within a facility. Such hand washing stations generally have one or more dispensers for soaps, degreasers or other cleansers for workers to remove dirt, grease, debris and the like from their hands. Typically, such stations are located near a water source, thus limiting the location of the cleansing stations. Typically, towels or wipers are also made available for workers to use to clean and/or dry their hands. Additionally, a trash receptacle is also usually available for used towels, wipers, debris, and the like.

Often, protective hand care items are also made available to workers. Such items may include gloves, barrier creams, lotions, or the like which are provided to workers to help them protect their hands prior to or during work. Other protective gear (e.g., smocks, jump suits, disposable pants and/or jackets, face masks, goggles, and the like) is also often available to the workers. In some cases, such protective articles are made available in the same location as the hand cleaning station, but in many cases the protective articles are only available in another location, separate from the cleaning station. Some individual items may only be available at different locations.

Such an assemblage of locations causes problems with inefficiency and inconvenience for workers having to visit multiple, different locations to meet their hand care and protective apparel needs. Additionally, inefficiency often occurs as the centralized location may need to be near a water source, which may not be located proximate to where the worker needs the station. There is an inherent loss of productivity that is associated with a worker having to travel to multiple locations to obtain the products they need. Multiple locations and a multitude of products also results in maintenance personnel needing to check and replenish those multiple locations.

Another problem with such stations is the fact that different types of soaps, towels, wipers, and other items often require their own product-specific dispensers due to the specific dispensing needs of the item. When new products are introduced to the station or old products are replaced, new dispensers often need to be installed and old dispensers removed. Finally, such a variety of dispensing needs often results in a multitude of various dispensers and shelving, each having their own size and shape. Such a variety of dispensers and shelving often produces an unsightly and cluttered work area.

### DEFINITIONS

As used herein, the term “fasteners” means devices that fasten, join, connect, secure, hold, or clamp components together. Fasteners include, but are not limited to, screws, nuts and bolts, rivets, snap-fits, tacks, nails, loop fasteners, and interlocking male/female connectors, such as fishhook connectors, a fish hook connector includes a male portion with a protrusion on its circumference. Inserting the male portion into the female portion substantially permanently locks the two portions together.

As used herein, the term “couple” includes, but is not limited to, joining, connecting, fastening, linking, or associating two things integrally or interstitially together. As used herein, the term “releaseably connect(ed)” refers to two or more things that are stably coupled together and are at the same time capable of being manipulated to uncouple the things from each another.

As used herein, the term “configure” or “configuration” means to design, arrange, set up, or shape with a view to specific applications or uses. For example: a military vehicle that was configured for rough terrain; configured the computer by setting the system's parameters.

As used herein, the term “hinge” refers to a jointed or flexible device that connects and permits pivoting or turning of a part to a stationary component. Hinges include, but are not limited to, metal pivotable connectors, such as those used to fasten a door to frame, and living hinges. Living hinges may be constructed from plastic and formed integrally between two members. A living hinge permits pivotable movement of one member in relation to another connected member.

As used herein, the term “substantially” refers to something which is done to a great extent or degree; for example, “substantially covered” means that a thing is at least 95% covered.

As used herein, the term “alignment” refers to the spatial property possessed by an arrangement or position of things in a straight line or in parallel lines.

As used herein, the terms “orientation” or “position” used interchangeably herein refer to the spatial property of a place where or way in which something is situated; for example, “the position of the hands on the clock.”

As used herein, the term “consumer” refers to a person (or persons) who may be responsible for selecting, purchasing, providing, installing, maintaining, refilling, configuring, and/or other similar administrative functions related to the system, its components, and/or the products dispensed from such a system. As used herein, the term “user” refers to person who may use the system and/or the products dispensed from such a system.

These terms may be defined with additional language in the remaining portions of the specification.

### SUMMARY OF THE INVENTION

In light of the problems and issues discussed above, it is desired to have a modular hand care system that provides a variety of hand care items in a fully customizable and expandable format. It is further desired that such a system be capable of being used at a central location within a consumer's facility or at multiple free-standing locations of the consumer's choosing. Such a system should make it easy for the consumer to replenish products, to replace old product dispensing modules with new product modules, and to add new product modules to the system when available.

The present invention is directed to a modular hand care system that is customizable and expandable in its design. Various hand care items are made available in various modules, each module being similar in design such that the modules may be connected in any configuration of the consumer's choosing. The consumer may also select as many modules as they desire to meet the specific needs of their facility and the needs of the users of the system. The modular nature of the system allows for easy replacement of individual modules and the installation of additional modules, as the consumer's needs change. Such a system can be used at any location of the consumer's choosing; the system may be mounted on a wall, on a movable cart, or may be installed within a frame system.

The modular system may have individual modules capable of dispensing hand care items such as, by way of non-limiting example, soap, foaming soap, cleansing grit, lotion, barrier cream, degreaser, gloves, towels, paper towels, wipers, pre-saturated wipers, and the like. Additionally, such a system may be capable of dispensing other items such as, by way of non-limiting example, protective garments, safety apparel, goggles, face masks, face shields, and the like. Additionally, such a system may additionally include a waste disposal unit.

The hand care system may be provided by to the consumer by providing first and second hand care dispensing modules. The first dispensing module may be releaseably connected to a support and the second dispensing module may then be releaseably connected to the first dispensing module. In various alternate embodiments, a third dispensing module may be provided and releaseably connected to a support, to the first dispensing module, to the second dispensing module, or any combination of connections thereof. In various alternate embodiments, different types of hand care products may be provided in the individual dispensing modules, the modules may be configured to receive additional hand care products, the modules may be configured to be non-refillable, or the modules may be configured to receive a cartridge of products.

The hand care system may be provided to the consumer as an array of interchangeable hand care dispensing modules that include an array of hand care product types. Information regarding the full range of products available may also be provided to the consumer to enable them to select the hand care products that meet their needs. In some embodiments, such dispensing modules may include indicia that assist the consumer in determining the product contained within any particular dispensing module.

The customizable and expandable modular hand care system may include a plurality of interchangeable dispensing modules, a plurality of hand care products contained within such modules, and a support to hold the modules during the dispensing of the products. Modules that may be used in such a system may include a housing, a dispensing opening and a mount configured to releaseably connect the module to a support. In some embodiments, the module may additionally include a connector configured to releaseably connect the dispensing module to another dispensing module. In various alternate embodiments, the mount may be a fastener, a portion of the housing shaped to releaseably connect to a support, or combinations thereof. In other embodiments, the connector may be a first connector component present on a first side of the housing and second connector component on a second side of the housing.

### BRIEF DESCRIPTION OF THE DRAWINGS

FIG. 1 is a perspective view of several dispensing modules coupled together, and shows additional dispensing modules being coupled to form a hand care system according to the present invention;

FIG. 2 is a perspective view of a centralized hand care station having modules inserted in a frame support system to form a hand care system according to the present invention;

FIG. 3 is a perspective view of a dispensing module according to the present invention;

FIG. 4 is a cross-sectional side view of dispensing module releaseably connected to a support; and

FIG. 5 is a perspective view of a modular hand care system according to the present invention, configured around an existing installation.

### DETAILED DESCRIPTION

Reference will now be made in detail to one or more embodiments of the invention, examples of which are illustrated in the drawings. Each example and embodiment is provided by way of explanation of the invention, and is not meant as a limitation of the invention. For example, features illustrated or described as part of one embodiment may be used with another embodiment to yield still a further embodiment. It is intended that the invention include these and other modifications and variations as coming within the scope and spirit of the invention.

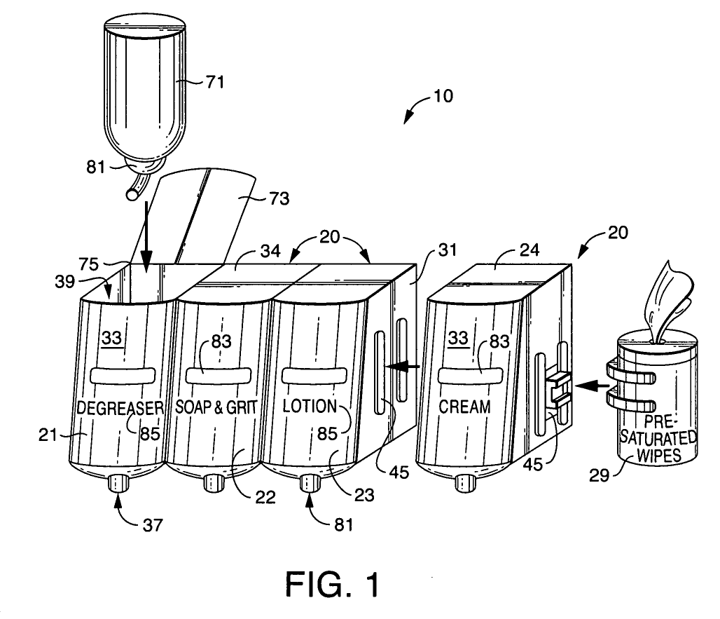

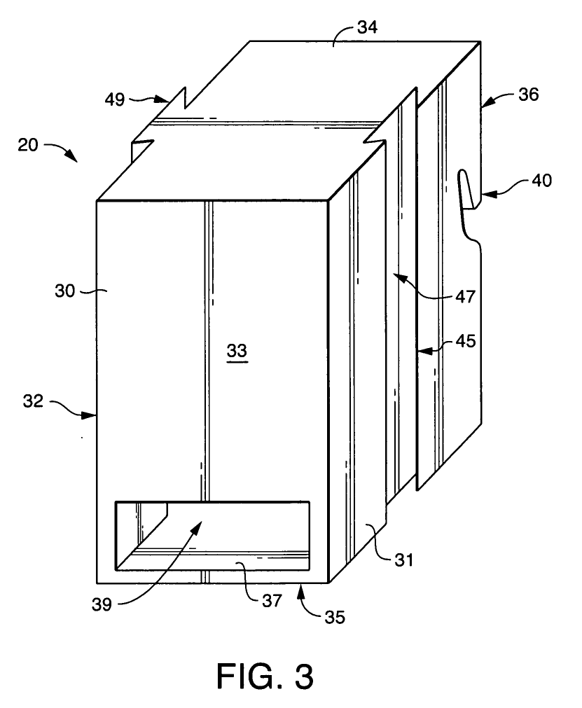

Referring to FIGS. 1, 2 and 3 in general, the modular hand care system 10 of the present invention is based on individual dispensing modules 20 that each contain an item that is desired to be dispensed in a single location. As shown in FIGS. 1 and 3, each module 20 may include a housing 30, a dispensing opening 37, and a mount 40. Additionally, each module 20 may have a connector 45.

The housing 30 is the basic structure of the module 20 and has a plurality of surfaces that generally define an interior area 39 in which the product to be dispensed is contained and from which the product is dispensed therefrom. Product within the interior area 39 of the module 20 is dispensed through the dispensing opening 37. The mount 40 is configured to releaseably couple the module 20 to a support 60. Finally, if present, the connector 45 is located on the housing 30 and allows for individual modules 20 to be releaseably coupled to one another.

In regard to the connection of the modules 20 to a support 60 or to another module 20, the term “releaseably connect” refers to such a connection to the support 60 or module 20 that is stable once made, but that is capable of being disconnected/detached when desired.

Any variety of hand care products may be dispensed with the modular system 10 including, but not limited to, cleansers, hand care substances, protective garments, wiping substrates, and the like. Cleansers may include any substance that is used to cleanse the hands and skin. These may include, but are not limited to, soap, foaming soap, cleansing grit, waterless cleansers, degreasers and the like. Hand care substances may include any substance that is used to preventatively protect the skin or help heal the skin. These hand care substances may include, but are not limited to, lotions, barrier creams, ointments, medicants, and the like.

Protective garments that may be dispensed with the modular system may include any type of garment that is worn to protect the wearer from hazards, to minimize contact with the working environment, to keep the wearer and/or their clothes clean, or otherwise cover a portion of the wearer's person. Any of such protective garments may be durable items intended for multiple uses or may be disposable items intended for single- or limited-use. Such protective garments may be related to hand care such as gloves, wrist wraps, finger cots, or the like. Other protective garments that may be dispensed may include, but are not limited to, smocks, coverings, protective suits, fire retardant suits, chemical suits, hazardous materials suits, masks, face shields, goggles, and the like.

Wiping substrates that may be dispensed with the modular system 10 may include wipers, towels, pre-saturated wipers, and the like. Such substrates may be stacked, folded, interfolded, rolled, or in any format as are known for such substrates.

Similarly, such a modular system may be used to dispense other products not necessarily associated with hand care, including but not limited to sanitizers, disinfectants, mops, cleaning supplies, janitorial supplies, and the like. Any item that is typically dispensed in a consumer's facility may be configured to be dispensed by such a modular dispensing system.

The housing 30 of the modules 20 may have a plurality of sides that generally define an interior area 39. The sides of the housing 30 may completely enclose the interior area 39, as shown in the modules 20 in FIGS. 1 and 3. As seen in FIG. 3, the module 20 may have a first side 31, a second side 32, a front face 33, a back face 36, a top 34, and a bottom 35. Alternatively, the housing 30 may not completely enclose the entirety of the interior area 39. In such alternative housing configurations, the interior area 39 may generally be defined by a plurality of surfaces, which may or may not be contiguous relative to each other.

As used herein, the “interior area” refers to a three-dimensional space, or volume, generally defined by the structure (i.e., sides or surfaces) of the housing 30. The interior area 39 is configured to contain the hand care products and to dispense such products from the interior area 39. The terms “interior volume”, “interior space”, and “interior area” may be used interchangeably herein, in reference to the housing 30.

The housing 30 may be made from any material that is appropriate to contain and dispense the product of the particular module 20, allow the module 20 to be coupled to other modules 20 by connectors 45 on the housing 30, and allow the module 20 to be mounted to a support 60 by a mount 40. Non-limiting examples of materials suitable for the housing 30 may include plastic, metal, paperboard, cardboard or any combination thereof.

Such housings 30 may be designed such that the individual module 20 may be refilled. For example, a wall of housing 30 may be hinged such that additional product may be added to the particular module 20 (i.e., additional folded towels added, soap refilled, etc.). Rather than refilling product directly into the interior area 39 of the housing 30, the housing 30 may be configured to receive a cartridge 71 of the product to be dispensed. For example, as shown in FIG. 1, a product may be delivered to the housing 30 in cartridge 71. The housing 30 of the first dispensing module 21 of FIG. 1 has a lid 73 on a hinge 75 that allows the cartridge 71 to be inserted into the interior space 39 of the housing 30. When one cartridge 71 is consumed, the used cartridge 71 may be removed and a new cartridge 71 inserted into the interior space 39 of the module 20. Such a cartridge 71 refill is a quick and easy method of refilling the module 20 and helps avoid any mess that may be associated with pouring additional liquids (i.e., soaps, degreasers, etc.) into the interior area 39 of the housing 30 or overstuffing the housing 30 with wiping products (i.e., towels or wipers).

Alternatively, the housing 30 may be configured to be non-refillable. Such housings would be delivered to the consumer filled with the product to be dispensed. Once all of the product is dispensed, the module 20 may be removed from the system 10 and disposed. Alternatively, the non-refillable housing 30 may be designed and made of appropriate materials such that it is capable of being recycled, rather than being disposed. Such a disposable/recyclable module 20 would eliminate the mess and/or time for refilling of the module 20 and allow for the quick and easy maintenance of the system 10.

The housing 30 of the modules 20 of the system 10 are intended to be similar enough in size and shape such that they may be easily interchanged and configured in any manner that the consumer desires. However, individual modules 20 may have variations in size and shape but still work together such that the modules 20 may be easily interchanged and configured as desired. Such cooperation of the housings 30 allows new modules 20 to easily be added, old modules 20 removed or replaced, or multiples of the same module 20 be included in the system 10.

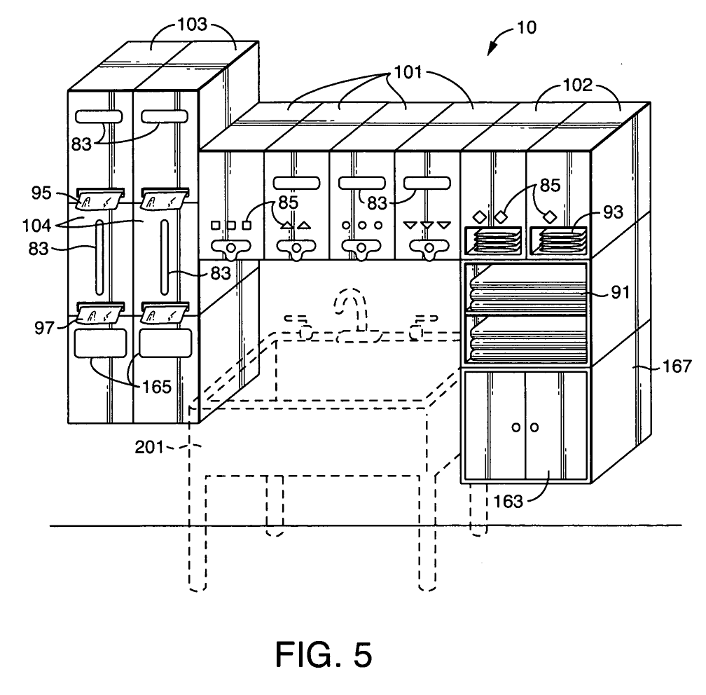

For example, the modular dispensing system 10 shown in FIG. 5 shows modules 101, 102, 103, 104 that are similar in size and shape that have been configured around an existing installation. Additionally, the system 10 may include larger modules 20 such as larger hand care product dispensers, or such as the shelving module 167 and storage cabinet module 163 shown in FIG. 5. Such larger modules 167, 163 desirably have dimensions that are multiples of the dimensions of the dispensing modules 20 such that the larger modules may easily be configured with the dispensing modules 20 into a dispensing system 10 as the consumer desires. As shown in FIG. 5, the shelving module 167 and the storage cabinet module 163 is approximately the size of two dispensing modules 20.

Additional functionality may be included in the design of the housing 30. The housing 30 may include a secondary opening or window 83 such that the consumer may see the amount of product remaining to be dispensed from the module 20 in order to gauge when the module 20 may need to be refilled or replaced.

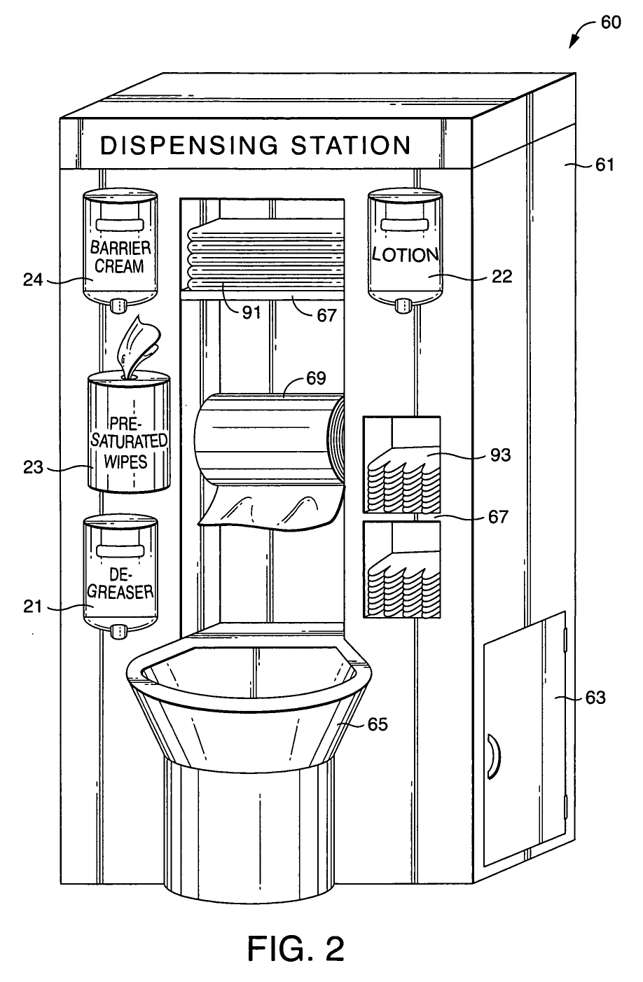

Another functionality may be indicia 85 included on the housing 30 to help communicate to the consumer and/or users how the module 20 is to be installed, what is contained within the module 20, how to dispose of the module 20, how to use the product contained within, cleaning instructions, or other similar information to be communicated to a consumer or that the consumer wishes to convey to users. Such indicia 85 may be any word(s), numeral(s), line(s), symbol(s), picture(s), physical shape(s), color(s), texture(s) and/or combination(s) thereof, and so forth, which communicates to the consumers and users a desired message. In the systems 10 shown in FIGS. 1 and 2, the modules 21, 22, 23, 24 include indicia 85 in the form of labels that indicate the product within the module. Alternatively, the system 10 illustrated in FIG. 5 uses symbols as indicia 85; the particular symbols used and/or the number of such symbols may be used to indicate the product type, size, grade, and/or other such distinctions regarding the product contained within the particular module.

Instructions may also be included with, or printed on, the housing 30. Such instructions may help the consumer select the modules 20 based on their needs and the modules 20 available. The instruction may inform the consumer as to how the modules 20 may be coupled together, how to mount the modules 20 to the support 60, cleaning instructions for users and consumers, module disposal, product replenishment, and/or other similar type information.

The dispensing opening 37 of the module 20 is the portion of the module 20 through which the product contained within the module 20 is dispensed. The dispensing opening 37 may be an integral portion of the housing 30. In embodiments where the product is delivered to module 20 as a disposable cartridge 71, the dispensing opening 37 may include an integral part of the cartridge 71 that is allowed to extend through an opening in the housing 30.

The product contained within the module 20 is dispensed through the dispensing opening 37 and thus the dispensing opening 37 should be appropriate for the particular product being dispensed. For liquids and gels (i.e., soaps, degreasers, grit cleanser, etc.), the dispensing opening 37 may incorporate a pump 81, a valve, a spigot, and/or other such mechanical element as are well known for dispensing such substances. Additionally, such a dispensing opening 37 may be equipped with sensors that detect proximity of a users hand and dispense the product such that the user need not touch the module 20.

In particular modules 20 containing other items such as wipers, napkins, gloves, garments, or the like, the dispensing opening 37 may be an opening in the housing 30 that allows individual items to be removed from the module 20. Such an opening may be of a size and shape to help with the dispensing of the product and may include additional features, such as a tear bar to help tear off roll substrate being dispensed.

The modules 20 of the modular system 10 may include a connector 45 associated with the housing 30. A connector 45 allows the modules 20 to be releaseably coupled to each other. Such a connector 45 may cooperate with the mount 40 and the support 60 to allow the easy coupling and uncoupling (i.e., releaseably coupled) of the individual modules 20. Thus, various individual modules 20 may easily be added, configured, reconfigured, removed and replaced as the consumer sees fit. However, when coupled together and mounted on the support 60, the individual modules 20 may act as a unitary system.

Such connectors 45 may be as simple as an adhesive patch on a surface of the housing 30 that adheres to a side of another module 20. Another simple connector 45 for housings 30 made of metal would be a magnetic surface on one side of the housing 30 that would then attach to any portion of the metallic surface of another module 20.

Alternatively, the connector 45 may be a cooperative pair of mating surfaces present on opposite sides of the module housing 30. For example, a vertical raised portion may be located one side of the module housing 30 and a matching vertical slot may be present on the opposite side of the module housing 30. As such, the slot on one side of any module housing 30 would be capable of coupling with the vertical raised portion on the opposite side of another module housing 30; thus, any module 20 may be coupled with another module 20. Additionally, combinations of housing shapes or cooperative fasteners may be used as connectors 45. Other non-limiting examples of connectors 45 on opposite sides of the housing 30 from each other may include, hook fasteners and loop fasteners, raised portions and recessed portions, and/or metal plates and magnets.

This type of matched connector 45 is illustrated in FIG. 3. A first connector component 47 is present on the first side 31 of the housing 30 in the form of a rectangular dove-tail recess while a matching second connector component 49 in the form of a rectangular dove-tail projection is present on the second side 32 of the same housing 30. A second dispensing module having the same configuration as the dispensing module 20 shown in FIG. 3 may be releaseably connected to the module 20 shown by aligning the second connector component 49 of the second dispensing module with the first connector component 47 of the module 20 shown and sliding the two modules together.

While the first and second connector components 47, 49 are shown in FIG. 3 as a dove-tail connector, other cross-sectional shapes are possible. Additionally, more than one set of connectors 45 may be present on a single side of the housing; multiple parallel columns of first connector components 47 may be present on a first side 31 along with matching multiple parallel second connector components 49 present on the second side 32 of the housing 30.

Alternatively, the matched connector components 47, 49 may be a different configuration from the grove/protrusion configuration of FIG. 3. For example, the first connector component 47 may be a plurality of cylindrical posts extending from the first side 31 and the second connector component 49 may be a plurality of cylindrical recesses on the second side 32 that accept the cylindrical posts. As discussed above, fasteners may be used as the connectors 45 or may be used in addition to other matched connector components.

The connector components 47, 49 as shown in FIG. 3 would allow a second connector component 49 to completely slide through the first connector component 47. Instead, either of the connector components may additionally include a stop that would allow the components to fit snuggly together. This may be accomplished by closing off one end of the first connector component 47 or tapering the shape of the components 47, 49 in one direction (i.e., thus only allowing another module to be connected from above or from below the module 20 in FIG. 3), having a protrusion associated with the second connector component 49 that would snap into a depression associated with the first connector component 47, an additional part that may be added to lock the modules into position, or other similar means that would fit the modules 20 snuggly together.

The connectors 45 in FIG. 3 are also shown in a vertically orientation, however, the connectors 45 may be horizontally oriented (i.e., running from the front of the housing 30 to the back), diagonally oriented (e.g., running from the top front edge toward the lower back edge of the module 20), or other orientations or configurations. Additionally, connectors 45 may alternatively, or additionally, be present on the top surface 34 and the bottom surface 35 of the housing 30. Having connectors 45 on horizontal surfaces (top 34 and bottom 35) as well as the vertical surfaces (first and second sides 31, 32) allows for a dispensing system 10 that may be configured and expanded in both a vertical and horizontal orientation. The dispensing system 10 shown in FIG. 5 is one example of such a horizontal and vertically configured system 10.

The dispensing system 10 shown in FIG. 5 also illustrates that the system 10 may be configured in non-symmetrical configurations. Rather than all of the modules 20 aligning in a horizontal plane, such as the cleanser modules 101 and the glove dispensing modules 102 relative to each other, the towel dispensing modules 103, wiper dispensing modules 104, and waste receptacle modules 165 are vertically offset from the cleanser modules 101. The availability of such configurations may be particularly advantageous in areas where the dispensing system 10 may need to be placed in areas with existing installations (such as a sink 201, stairwell, pipes, machinery, and the like).

In certain circumstances, consumers may desire that particular products be kept separate or particular products cannot, or should not, be used in combination. In such instances, the connectors 45 of such modules 20 may be designed so that those particular product modules 20 are incompatible for coupling. Where desired, the incompatibility may be accomplished through use of different types of connectors 45 or by simply reversing the sides of the mated connectors 45 such that those particular modules 20 may not be coupled together.

The modular system 10 may additionally include an auxiliary dispenser 29 that is adapted to work with the individual modular housings. By way of non-limiting example, the system 10 shown in FIG. 1 includes four similar modules 21, 22, 23, 24 coupled together and an additional auxiliary dispenser 29 coupled to those modules. In the example of FIG. 1, a pre-saturated wiper dispenser 29 is coupled to the end of the four coupled modules 21, 22, 23, 24. Such an auxiliary dispenser 29 may be configured to work with the connectors 45 of the module housing 30.

The mount 40 is associated with the housing 30 and is configured to releaseably couple the housing 30 to a support 60. Such a mount 40 may be an integral portion of the housing 30 or it may be an additional piece that is affixed to the housing 30. The mount 40 may be a fastener that attaches the module 20 to the support 60. Non-limiting examples of such fasteners may include hook and loop fasteners, pressure-sensitive adhesives, tapes, screws, nails, or other such fasteners as are well known.

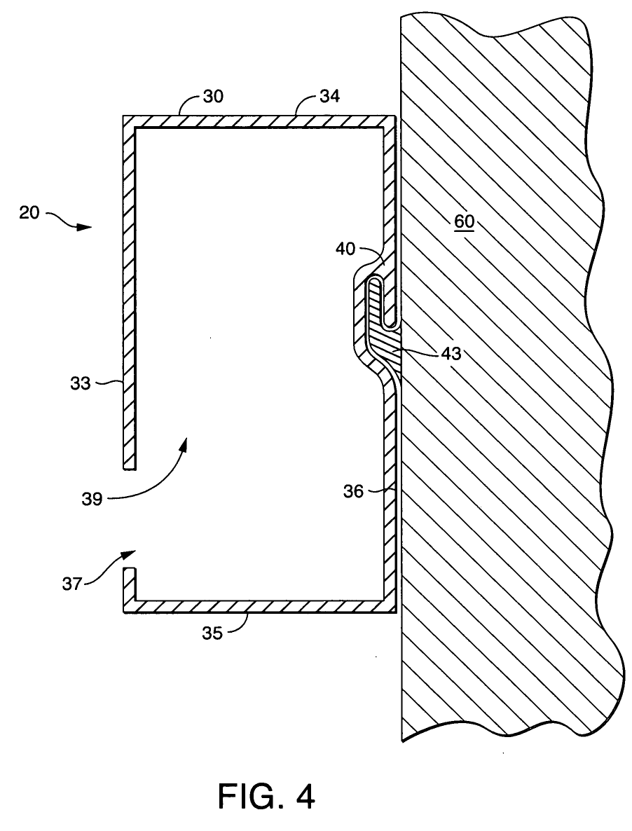

Alternatively, or in addition, the mount 40 may be a particular shape or design present on the housing 30 such that the housing 30 cooperates with the support 60. For example, the back 36 of the housing 30 may have a vertical slot that cooperates with a post on the support 60 to secure the housing 30 to the support 60. Similarly, the overall shape of the housing 30 may be designed to securely fit within or on the support 60. Such a mount 40 is illustrated in FIGS. 3 and 4.

It is intended that modular system 10 be designed such that it may be mounted to a support 60. Such a support 60 may simply be a vertical surface, such as a wall or a post, located wherever the consumer desires the system 10 to be made available. The modular system 10 may be mounted directly to the vertical surface using the individual mounts 40 of the individual modules 20 or it may mounted to a fixture mounted on the vertical surface. For example, a horizontal rail or system of horizontal rails may be mounted as a wall fixture that cooperates with the mounts 40 of the individual modules 20 to secure the modules 20 to the vertical surface.

As shown in FIG. 4, a bracket 43 may be installed on the surface of the support 60. The mount 40 on the back wall 36 of the module 20 may be configured to snuggly fit on the bracket 43 to releaseably connect the module 20 to the support 60. A system 10 such as shown in FIG. 1, may be releaseably connected to the support 60 using a single bracket 43 for each module 21, 22, 23, 24. Alternatively, not all of the module mounts 40 need to be used to connect the modules 20 to a support 60. The system 10 of FIG. 1 may instead be releaseably connected to the support 60 using a single bracket 43 that supports the second dispensing module 22, where the first dispensing module 21 and third dispensing module 23 are then releaseably connected to the second module 22 by connectors 45. Alternatively, a pair of brackets 43 may releaseably connect the first dispensing module 21 and the fourth dispensing module 24 to a support 60, while the second and third dispensing modules 22, 23 are releaseably connected to the first and fourth dispensing modules 21,24 using connectors 45.

One skilled in the art would see that there are many combinations of types of module mounts 40, brackets 36 or other support fixtures, and connectors 45 that may be used to configure the system 10 to the needs and desires of the consumer. The connectors 45 allow the consumer to releaseably connect the dispensing modules 20 they desire into any configuration that they wish. The consumer has the flexibility to choose the method and number of fixtures that they desire to releaseably connect the unitary module configuration to a support 60 in such a way as meets the needs, desires, spatial constraints and imagination of the consumer.

As shown in FIG. 2, the support 60 may be a frame system 10 into which various modules 20 may be mounted. Various recesses may be made available within the frame 61 such that individual modules 20 may be inserted. With similarly sized and shaped modules 20, the consumer would be free to place individual modules 20 in any available recess they desire. Recesses that are unused by modules 20 may be occupied by stacks of goods, such as garments 91 or gloves 93, as shown in FIG. 2. Such a frame system 10 may be designed for a fixed centralized location, or it may have wheels such that it may be easily moved to any location that it is needed.

The frame 61 may be a fully fleshed out structure with recesses as shown in FIG. 2 or it may have a simpler structure. The frame 61 need only be a structure that can support and hold the modules 20 while the product is dispensed. For example, the frame 61 may be a shelving unit on which releaseably connected sets of modules may be placed. Alternatively, the frame 61 may be a simple rolling cart having a few posts with brackets on which the modules may be mounted. Other frames 61 may be more or less complex than those shown and discussed.

Such a frame system 10 may be advantageously configured by the consumer to group certain product types together. A consumer may want to keep certain products used by worker in preparation for their work separated from those products used by workers during, or at the completion of, their work. For example, it may be desirable to dispense garments a worker may wish to don prior to working with grease separated from the degreaser dispenser which will be used by workers after their hands become covered with the grease. The consumer, in this case, may have a “clean” side to the frame 61 and a “dirty” side. In FIG. 2, the consumer may accomplish this configuration by selecting appropriate modules 20 for the left side of the frame 61 and appropriate modules 20 for the right side of the frame 61. Alternatively, the frame system 10 may include recesses on opposite faces of the frame system 10 such that the consumer may separate certain products to opposite sides of the frame 61 (i.e., front side vs. back side).

Additionally, such separation may be assisted with a modular system 10 where products to be separated may be contained in modules 20 having different size, shapes, connectors 45, and/or mounts 40. Such differences may cooperate with the particular frame 61, or other support 60, such that only certain modules 20 may be coupled or grouped together.

The frame 61 may include additional functionalities. These additional functionalities, may include dispensing of products not contained within a modular housing 30, waste disposal, storage of refills for dispensed product or replacement modules 20, water supply, or other similar functionalities as the consumer may find helpful. As a non-limiting example, FIG. 2 shows a modular system 10 that includes the additional functionality of waste disposal 65, rolled product dispensing 69, and shelving 67 for storage and dispensing of garments and gloves. Such a frame system 10 may additionally include a storage cabinet 63 in which refills, additional modules 20, or other products may be stored.

Some the above mentioned additional functionalities may be provided in the form of specific modules. The additional functionality modules may have the same basic structure of the dispensing modules 20 such that these additional modules may releaseably connect with the dispensing modules 20 of a dispensing system 10. FIG. 5 illustrates several of such additional functionality modules. For example, the system 10 may include a shelving module 167 which may be used to dispense larger items such as garments 91. Other modules may include a storage cabinet module 163 and waste receptacle modules 165.

Additionally, indicia 85 may be added to the support 60 to help communicate to the consumer and/or users how the modules 20 are to be installed on the support 60, how to use the support 60, how to dispose of the modules 20, how to use the products contained within the modules 20, cleaning instructions, or other similar information that the consumer wishes to convey. Such indicia may be any word(s), numeral(s), line(s), symbol(s), picture(s), physical shape(s), color(s), texture(s) and/or combination(s) thereof, and so forth, which communicates a desired message.

Instructions may also be included with, or printed on, the support 60. Such instructions may help the consumer select the modules 20 based on their needs and the modules 20 available. The instruction may inform the consumer as to how the modules 20 may be configured and/or coupled together, how to mount the modules 20 to the support 60, cleaning instructions, module disposal, product replenishment, and/or other similar type information.

In use, the consumer may select any combination, number, and configuration of modules 20 that they desire. The system is fully customizable in that the consumer may select any module, with any type of hand care product, any number of such modules, and provide the modules/product to a user in any configuration and orientation that the consumer requires and desires. The system is expandable in that the consumer may easily add modules to or subtract modules from an existing system. The customizability and expandability of the system gives the consumer the flexibility to meet their needs and the needs of their facility and their users.

As shown in FIG. 1, the consumer has selected modules 21, 22, 23, 24 to dispense degreaser, soap with grit, lotion, and cream. Additionally, the consumer has selected a pre-saturated wiper auxiliary module 29 that is coupled to the end of the other modules 21, 22, 23, 24. In FIG. 2, the consumer has selected a frame 61 on to which various modules 20 are mounted. This consumer has selected different types of hand care products, each in their own module 20; the consumer has selected barrier cream, lotion, and degreaser modules 20 along with an auxiliary pre-saturated wiper module 29. With this particular frame system 10, the consumer also is dispensing gloves, garments and rolled dry wipers. Additionally, waste disposal 65 is incorporated into the frame system 10.

In both of the exemplary modular systems 10 of FIGS. 1 and 2, the consumer selected different individual product modules 20. Other configurations of the same modules 20 would be possible for either of the exemplary modular systems 10 shown. Additionally, alternate product modules 20 may be used, additional product modules 20 may be added, or duplicates of individual product modules 20 may be used with either of the illustrated modular systems.

The consumer may be provided with an array of hand care products in an array of modules 20 configured for dispensing particular products. Information provided to that consumer may help them decide which particular products they wish to provide and what particular modules are right for their facility. Indicia 85 may be present on the individual modules 20 to assist the consumer in keeping track of what product is contained in modules 20, which may be otherwise similar in appearance, size and shape. The instructions may additionally help the consumer match the indicia 85 with the desired product/modules.

Once the types and number of modules are selected, the consumer may assemble the modules 20 into any configuration that the connectors 45, the mounts 40, the support 60, the spatial constraints of the consumer's facility, and the consumer's imagination will allow. As discussed above, the consumer may start out by releaseably connecting a first dispensing module 21 to a support 60. A second dispensing module 22 may then be releaseably connected to the first dispensing module 21, to a support 60, or to both. The consumer may then continue to releaseably connect additional modules to the first and second dispensing modules 21, 22, to a support 60, or to both. Each of the modules may contain and dispense the same hand care product, different hand care products, other protective garments, or combinations thereof.

It will be appreciated that the foregoing examples and discussion, given for purposes of illustration, are not to be construed as limiting the scope of this invention, which is defined by the following claims and all equivalents thereto.

We claim:

1. A method for providing a hand care system, the method comprising the steps of:
a.) providing at least a first hand care product dispensing module, wherein the first dispensing module comprises a housing, a dispensing opening, and a hand care product, wherein the hand care product is contained within the housing and said product is dispensed through the dispensing opening;
b.) connecting the first dispensing module to a support;
c.) providing at least a second hand care product dispensing module, wherein the second dispensing module comprises a housing, a dispensing opening. and a hand care product, wherein the hand care product is contained within the housing and said product is dispensed through the dispensing opening; and
d.) connecting the second dispensing module to the first dispensing module.

2. The method of claim 1, further comprising the step of connecting the second dispensing module to a support.

3. The method of claim 1, further comprising the steps of providing at least a third hand care product dispensing module, wherein the third dispensing module comprises a housing, a dispensing opening, and a hand care product, wherein the hand care product is contained within the housing and said product is dispensed through the dispensing opening.

4. The method of claim 3, further comprising the step of connecting the third dispensing module to the second dispensing module.

5. The method of claim 3, further comprising the step of connecting the third dispensing module to the first dispensing module.

6. The method of claim 3, further comprising the step of connecting the third dispensing module to a support.

7. The method of claim 6, further comprising the step of connecting the third dispensing module to the second dispensing module.

8. The method of claim 6, further comprising the step of connecting the third dispensing module to the first dispensing module.

9. The method of claim 1, wherein the type of hand care product contained within the first dispensing module is different than the type of hand care product contained within the second dispensing module.

10. The method of claim 3, wherein the type of hand care product contained within the first dispensing module is different than the type of hand care product contained within either the second dispensing module or the third dispensing module.

11. The method of claim 1, further comprising the steps of dispensing all of the product from the first dispensing module; detaching the first dispensing module from the support; detaching the second dispensing module from the empty first dispensing module; replacing the empty first dispensing module with a new first dispensing module filled with hand care products; connecting the new first dispensing module to the support; and connecting the second dispensing module to the new first dispensing module.

12. The method of claim 1, further comprising the steps of dispensing all of the product from the second dispensing module; detaching the second dispensing module from the first dispensing module; replacing the empty second dispensing module with a new second dispensing module filled with hand care products; and connecting the new second dispensing module to the first dispensing module.

13. The method of claim 1, wherein the first and second dispensing modules each comprise a housing configured to receive new hand care products after the hand care products originally contained within the dispensing modules have been dispensed.

14. The method of claim 1, wherein the first dispensing module is configured to receive a non-refillable cartridge containing hand care products, and wherein the hand care products are dispensed from the cartridge through the dispensing opening.

15. The method of claim 14, further comprising the step of dispensing the hand care product from the cartridge; removing the empty cartridge from the first dispensing module; and inserting a new cartridge into the first dispensing module.

16. A method of providing a hand care system, the method comprising the steps of:
a.) providing an array of interchangeable hand care product dispensing modules, wherein each module comprises a housing, a dispensing opening, a mount, and a connector;
b.) providing an array of hand care products types, wherein each type of hand care product is contained within and dispensed from one of the hand care product dispensing modules;
c.) providing information to the consumer corresponding to the range of hand care product types that are available, thereby enabling the consumer to select the particular hand care dispensing modules containing the hand care products that the consumer desires.

17. The method of claim 16, wherein the individual dispensing modules of the array of interchangeable dispensing modules each comprise a product indicia disposed on the housing indicating the type of hand care product contained within the individual dispensing module.

18. The method of claim 17, wherein the information provided to the consumer additionally enables the consumer to match the product indicia on the individual dispensing modules to the hand care products that the consumer desires to select.

19. A customizable and expandable modular hand care system comprising,
a plurality of interchangeable dispensing modules;
a plurality of hand care products, wherein the plurality of hand care products comprises at least two different types of hand care products and wherein the hand care products are contained within and dispensed from individual dispensing modules; and
a support, wherein the support holds the dispensing modules during dispensing of the product,
wherein each different type of hand care product is contained within and dispensed from a different individual dispensing module, and
wherein the dispensing modules are configured to be individually removed, individually replaced with other modules, and reconfigured as desired.

20. The system of claim 19, wherein the dispensing modules of the plurality of dispensing modules are similar in overall shape and size.

21. The system of claim 19, further comprising an auxiliary dispenser connected to a dispensing module.

22. The system of claim 19, further comprising a storage compartment.

23. The system of claim 19, further comprising a waste receptacle.

24. The system of claim 19, further comprising water source.

25. An interchangeable dispensing module for use with the dispensing system of claim 19, the dispensing module comprising,
a housing;
a dispensing opening; and
a mount disposed on the housing,
wherein the housing defines an interior space, the interior space configured to contain a hand care product and dispense said product through the dispensing opening, and
wherein the mount is configured to releaseably connect the dispensing module to the support.

26. The dispensing module of claim 25, further comprising a connector, wherein the connector is configured to releaseably connect the dispensing module to another dispensing module.

27. The dispensing module of claim 26, wherein the connector comprises a first connector component on a first side of the housing and a second connector component on a second side of the housing.

28. The dispensing module of claim 25, wherein the mount comprises a portion of the housing shaped to releaseably connect the dispensing module to the support.

29. The dispensing module of claim 25, wherein the mount comprises a fastener adapted to releaseably connect the dispensing module to the support.

30. The dispensing module of claim 25, wherein the dispensing module is configured to be non-refillable.

31. The dispensing module of claim 25, wherein the dispensing module is configured to be refilled with hand care products.

32. The dispensing module of claim 31, wherein the module is configured to accept a cartridge into its interior space.

33. The dispensing module of claim 32, further comprising a cartridge, wherein the cartridge is configured to contain a hand care product and dispense said product through the dispensing opening.

34. The dispensing module of claim 25, further comprising a secondary opening.

35. The dispensing module of claim 25, further comprising instructions.

36. The dispensing module of claim 25, further comprising indicia.

37. A dispensing module for use as a dispensing system, the dispensing module comprising,
a housing;
a dispensing opening;
a connector disposed on the housing; and
a mount disposed on the housing,
wherein the housing defines an interior space in which a product may be contained within and dispensed therefrom through the dispensing opening,
wherein the mount is configured to releaseably connect the dispensing module to a support, and
wherein the connector is configured to releaseably connect the dispensing module to another dispensing module.

38. The dispensing module of claim 37, wherein the connector comprises a first connector component on a first side of the housing and a second connector component on a second side of the housing, wherein the first connector component is configured to releaseably connect to the second connector component present on another dispensing module.

39. The module of claim 37, wherein the mount comprises a portion of the housing shaped to releaseably connect the dispensing module to a support.

40. The dispensing module of claim 37, wherein the mount comprises a fastener adapted to releaseably connect the dispensing module to a support.

41. The dispensing module of claim 37, wherein the dispensing module is configured to be non-refillable.

42. The dispensing module of claim 37, wherein the dispensing module is configured to be refilled with hand care products.

43. The dispensing module of claim 42, further comprising a replaceable cartridge fitted within the interior space, wherein the cartridge comprises a hand care product contained within the cartridge, and wherein the cartridge dispenses said product through the dispensing opening.

44. The dispensing module of claim 37, wherein the dispensing opening further comprises a pump.

45. The dispensing module of claim 37, further comprising a secondary opening.

46. The dispensing module of claim 37, further comprising instructions.

47. The dispensing module of claim 37, further comprising indicia.

48. A customizable and expandable modular hand care system comprising,
a support;
at least a first interchangeable hand care product dispensing module, wherein the first dispensing module is releaseably connected to the support; and
at least a second interchangeable hand care product dispensing module, wherein the second dispensing module is releaseably connected to the first dispensing module,
wherein the dispensing modules each comprise a housing, a dispensing opening, and a mount disposed on the housing,
wherein the housing comprises a plurality of surfaces defining an interior space,
wherein the interior space is configured to contain a hand care product and dispense said product through the dispensing opening, and
wherein the mount is configured to releaseably connect the dispensing module to the support.

49. The system of claim 48, wherein the first and second dispensing modules are similar in overall shape and size.

50. The system of claim 48, further comprising an auxiliary dispenser releaseably connected to either the first or second dispensing module.

51. The system of claim 48, wherein the dispensing modules further comprise a connector, wherein the connector is configured to releaseably connect the dispensing module to another dispensing module.

52. The system of claim 51, wherein the connector comprises a first connector component on a first side of the housing and a second connector component on a second side of the housing, wherein the first connector component of the first dispensing module is configured to releaseably connect to the second connector component of the second dispensing module.

53. The system of claim 48, wherein the mount comprises a portion of the housing shaped to releaseably connect the dispensing module to the support.

54. The system of claim 48, wherein the mount comprises a fastener configured to releaseably connect the dispensing module to the support.

55. The system of claim 48, wherein the dispensing module is configured to be non-refillable.

56. The system of claim 48, wherein the dispensing module is configured to be refilled with hand care products.

57. The system of claim 56, wherein the dispensing module is configured to accept a cartridge into its interior space.

58. The system of claim 57, wherein the dispensing module comprises a cartridge, wherein the cartridge is configured to contain a hand care product and dispense said product through the dispensing opening.

59. The system of claim 58, wherein the cartridge further comprises a pump that dispenses the hand care product from the cartridge through the dispensing opening.

60. The system of claim 48, wherein the dispensing module further comprises a secondary opening.
